(19) United States
(12) Patent Application Publication
(10) Pub. No.: US 2005/0211035 A1
(43) Pub. Date: Sep. 29, 2005

(54) Paper processing apparatus and image forming system

(76) Inventors: Masahiro Tamura, Tokyo (JP); Nobuyoshi Suzuki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/080,923

(22) Filed: Mar. 16, 2005

(30) Foreign Application Priority Data
Mar. 17, 2004 (JP) 2004-077015
Dec. 27, 2004 (JP) 2004-377214

(51) Int. Cl. B26D 7/00

(52) U.S. Cl. 83/109; 83/167

(57) ABSTRACT

The present invention provides a paper processing apparatus comprising punching means for punching a hole in a sheet of paper, which is capable of detecting not only the accumulation position of punch debris, but also whether or not a punch debris storage member is attached, and an image forming system in which this paper processing apparatus and an image forming apparatus are provided integrally or separately. The paper processing apparatus comprises a punching blade for punching a hole in a sheet of paper discharged from the image forming apparatus, a punch debris conveyor belt for conveying the punch debris that is punched out of the paper by the punching blade, and a punch debris guide for conveying the punch debris that falls from the punching blade to a punch debris storage hopper for storing the punch debris. A punch debris sensor is disposed in the paper processing apparatus in order to detect the accumulation surface of the punch debris in an accumulation direction of the punch debris, which accumulates in the punch debris storage hopper from the punch debris guide.

### BACKGROUND OF THE INVENTION

1. Field of the Invention

The present invention relates to a paper processing apparatus comprising punching means for punching a hole in a sheet of paper, and an image forming system in which this paper processing apparatus and an image forming apparatus are provided integrally or separately.

2. Description of the Background Art

An invention disclosed in Japanese Unexamined Patent Application Publication 2001-25995 is known as an example of this field of technology. This invention comprises a punch and a die for punching a hole in a sheet of paper, punch debris conveyance means for conveying punch debris produced when the punch and die punch a hole in the paper, and a punch debris box for receiving the punch debris conveyed by the punch debris conveyance means. A screw type conveyance apparatus is employed as the punch debris conveyance means, and the punch debris box is provided detachably on the outside of an image forming apparatus main body such that when the punch debris box is detached from the image forming apparatus main body, the punch debris conveying means are halted but the image forming apparatus continues to form images. Thus the punch debris is not scattered around the exterior of the apparatus as garbage, and the image formation operation is continued even when the punch debris box is detached, enabling, according to the description of the invention, an increase in image formation productivity.

An invention described in Japanese Unexamined Patent Application Publication H10-310317 is also well-known. This invention is provided with a punch debris sensor positioned in the upper interior of a recovery box for recovering punch debris, which detects whether the recovery box is full or not by detecting the accumulation position of the punch debris from a right-angled (horizontal) direction to the direction in which the punch debris accumulates. The punch debris sensor described in Japanese Unexamined Patent Application Publication H10-310317 is provided in the interior of the recovery box, and hence the punch debris introduced into the recovery box may become adhered to the punch debris sensor so as to block the detection portion. As a result, the punch debris sensor may issue a capacity detection signal as if the recovery box were full. To avoid this, it is proposed that a separate opening to the opening portion for introducing the punch debris be provided on the side portion of the recovery box, and that the sensor be provided on the apparatus main body so as to detect the accumulation position of the punch debris through this opening.

However, the recovery box is often mounted on the inside of an openable front cover, and hence the recovery box moves in conjunction with operations to open and close the front cover, which are necessary even when the punch debris is stored in the recovery box. When the accumulation position of the punch debris is detected through the hole provided on the side of the recovery box, the punch debris may fly out of the hole due to the force with which the front cover is closed. Even if the punch debris does not fly out of the hole, it may catch on the hole, causing the recovery box to be detected mistakenly as full. Furthermore, when the recovery box is detached, the punch debris sensor is shielded by a shielding plate provided separately so that the sensor detects that the recovery box has been detached. To detect that the recovery box has been detached using such a system, the shielding plate must be provided separately, which leads to increases in cost and the complexity of the constitutional components.

### SUMMARY OF THE INVENTION

It is therefore an object of the present invention to provide a paper processing apparatus capable of detecting not only an accumulation position of punch debris, but also whether or not a punch debris storage member is attached, an image forming apparatus comprising this paper processing apparatus, and an image forming system comprising this image forming apparatus.

A paper processing apparatus of the present invention Comprises paper conveyance means for conveying paper discharged from an image forming apparatus; punching means for punching a hole in the paper conveyed by the paper conveyance means; punch debris storage means for storing punch debris which falls from the punching means; and detection means constituted by a range sensor for detecting an accumulation height of the punch debris stored in the punch debris storage means.

A paper processing apparatus of the present invention comprises paper conveyance means for conveying paper discharged from an image forming apparatus; punching means for punching a hole in the paper conveyed by the paper conveyance means; punch debris conveyance means for conveying punch debris punched out of the paper by the punching means; punch debris storage means for storing the punch debris that falls from the punch debris conveyance means; and detection means constituted by a range sensor for detecting an accumulation height of the punch debris stored in the punch debris storage means.

A paper processing apparatus of the present invention comprises paper conveyance means for conveying paper discharged from an image forming apparatus; punching means for punching a hole in the paper conveyed by the paper conveyance means punch debris conveyance means for conveying punch debris punched out of the paper by the punching means; punch debris guiding means for conveying the punch debris that falls from the punching means to punch debris storage means for storing the punch debris; and detection means for detecting an accumulation surface of the punch debris from an accumulation direction of the punch debris which accumulates in the punch debris storage means from the punch debris guiding means.

An image forming system of the present invention is provided with a paper processing apparatus and an image forming apparatus for forming a visible image on a recording medium are provided integrally or separately. The paper processing apparatus comprises paper conveyance means for conveying paper discharged from an image forming apparatus; punching means for punching a hole in the paper conveyed by the paper conveyance means; punch debris storage means for storing punch debris which falls from the punching means; and detection means constituted by a range sensor for detecting an accumulation height of the punch debris stored in the punch debris storage means.

An image forming system of the present invention is provided with a paper processing apparatus and an image forming apparatus for forming a visible image on a recording medium are provided integrally or separately. The paper processing apparatus comprises paper conveyance means for conveying paper discharged from an image forming apparatus; punching means for punching a hole in the paper conveyed by the paper conveyance means; punch debris conveyance means for conveying punch debris punched out of the paper by the punching means; punch debris storage means for storing the punch debris that falls from the punch debris conveyance means; and detection means constituted by a range sensor for detecting an accumulation height of the punch debris stored in the punch debris storage means.

An image forming system of the present invention is provided with a paper processing apparatus and an image forming apparatus for forming a visible image on a recording medium are provided integrally or separately. The paper processing apparatus comprises paper conveyance means for conveying paper discharged from an image forming apparatus; punching means for punching a hole in the paper conveyed by the paper conveyance means; punch debris conveyance means for conveying punch debris punched out of the paper by the punching means; punch debris guiding means for conveying the punch debris that falls from the punching means to punch debris storage means for storing the punch debris; and detection means for detecting an accumulation surface of the punch debris from an accumulation direction of the punch debris which accumulates in the punch debris storage means from the punch debris guiding means.

### BRIEF DESCRIPTION OF THE DRAWINGS

The above and other objects, features, and advantages of the present invention will become more apparent from the following detailed description taken with the accompanying drawings, in which:

FIG. 1 is a perspective view showing the system constitution of an image forming system comprising an image forming apparatus and a paper post-processing apparatus according to an embodiment of the present invention;

FIG. 2 is a view showing the schematic structure of the interior of the image forming system;

FIG. 3 is a sectional view showing the schematic constitution of the image forming system along an A-A line in FIG. 2;

FIG. 4 is a view showing in detail a punching unit and a punch debris storage hopper;

FIG. 5 is a view showing a punch debris conveyance unit in detail, and the positional relationship between the punch debris conveyance unit, the punching unit, and the punch debris storage hopper;

FIG. 6 is a view showing the positional relationship between an attachment and capacity sensor mounted on a punch debris guide, and the punch debris storage hopper;

FIG. 7 is a view showing the attachment and capacity sensor mounted on the punch debris guide;

FIG. 8 is a plan view showing the constitution of the principal parts of a punch debris conveyance mechanism in the paper post-processing apparatus in a normal usage condition with a front cover closed;

FIG. 9 is a plan view showing the constitution of the principal parts of the punch debris conveyance mechanism in the paper post-processing apparatus when the front cover is open;

FIG. 10 is a perspective view showing the punch debris conveyance unit and the punch debris storage hopper;

FIG. 11 is a perspective view showing the positional relationship by which the attachment and capacity sensor is mounted on the punch debris storage hopper;

FIG. 12 is a perspective view of the punch debris conveyance unit and the punch debris storage hopper seen from a drive side of a punch debris conveyor belt;

FIG. 13 is a perspective view showing the positional relationship between the punch debris conveyance unit and the punch debris storage hopper when the front cover is open;

FIG. 14 is a perspective view showing the positional relationship between the punch debris conveyance unit and the punch debris storage hopper when the front cover is closed;

FIG. 15 is a perspective view showing a state in which the punch debris storage hopper is detached from the front cover when the front cover is closed;

FIG. 16 is a view showing a capacity position and a near-capacity position of the punch debris storage hopper;

FIG. 17 is a block diagram showing the electric constitution of the paper processing apparatus according to this embodiment;

FIG. 18 is a view illustrating a hole punching operation when a press punching system is employed in the punching unit;

FIG. 19 is a view showing the schematic constitution of a drive system for a pressing mechanism used to perform a pressing operation for hole punching;

FIG. 20 is a view illustrating a hole punching operation when a rotary punching system is employed in the punching unit;

FIG. 21 is a view showing the schematic constitution of a drive system for a rotary mechanism;

FIG. 22 is a flowchart showing a control procedure performed during standby to detect the attachment state of the punch debris storage hopper and the punch debris storage state;

FIG. 23 is a flowchart showing a control procedure performed during a copying operation to detect the attachment state of the punch debris storage hopper and the punch debris storage state;

FIG. 24 is a view showing the positional relationship between the attachment and capacity sensor and the punch debris storage hopper when the attachment and capacity sensor is disposed on the inside of the punch debris conveyance unit; and

FIG. 25 is a view showing the positional relationship between the attachment and capacity sensor and the punch debris storage hopper when the attachment and capacity sensor is disposed in a punch debris outlet part of the punch debris conveyance unit.

### DESCRIPTION OF THE PREFERRED EMBODIMENT

An embodiment of the present invention will now be described with reference to the drawings.

Note that in the following description, detection means correspond to an attachment and capacity sensor 43, 43a, 43b, paper conveyance means correspond to an inlet roller 1 and a conveyance roller pair 6, 7, punching means correspond to a punching unit 4, punch debris conveyance means correspond to a conveyance unit 5 and a punch debris conveyor belt 18, punch debris storage means correspond to a punch debris storage hopper 3, and control means correspond to a control apparatus 350 and a CPU 360.

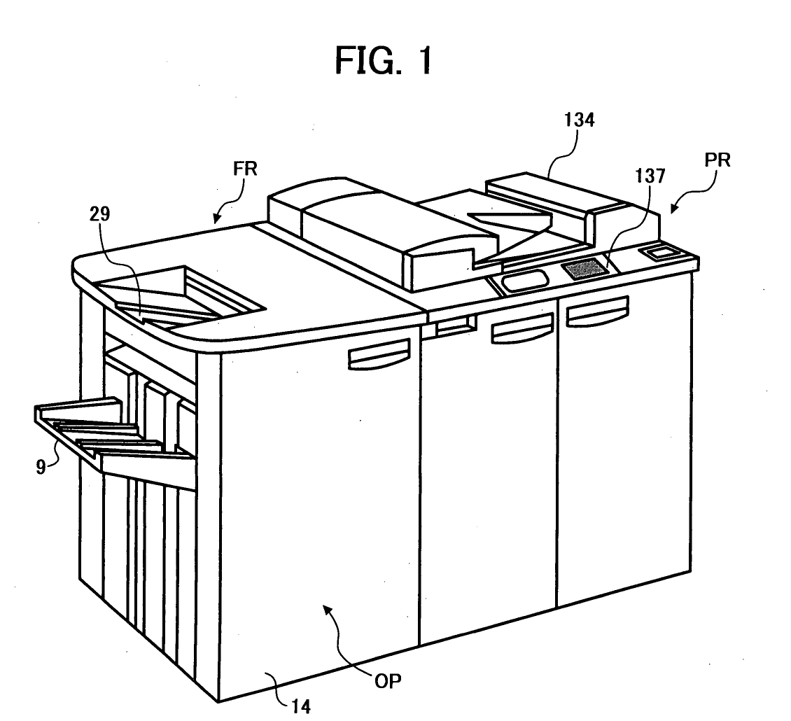

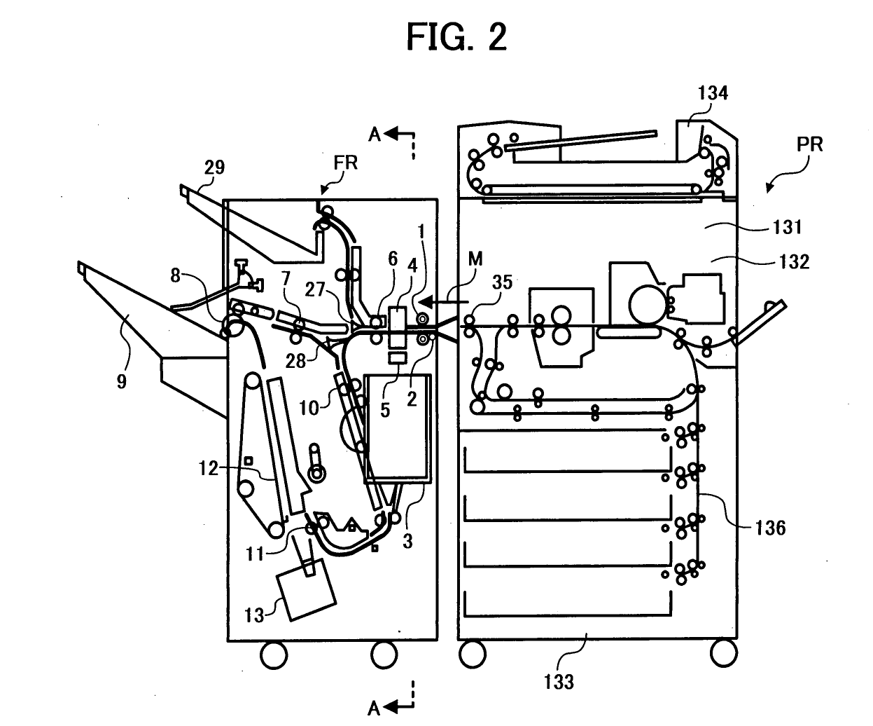

FIG. 1 shows the system constitution of an image forming system comprising an image forming apparatus PR and a paper post-processing apparatus FR serving as a paper processing apparatus according to an embodiment of the present invention, and FIG. 2 shows an outline of the internal structure of this image forming system. In these drawings, the image forming apparatus PR has a copying function, and is basically constituted by an image reading portion 131, an image writing portion 132, a feed portion 133, and an original feed portion 134. The image reading portion 131 is a well-known device which performs scanning in the main scanning direction using a so-called scanner, and reads an original when moved in the sub-scanning direction.

The original is fed onto a contact glass by the original feed portion 134, which is also known as an automatic document feeder (ADF), and read optically. The image writing portion 132 is constituted by a well-known optical system using a laser diode, a polygon mirror, an fθ lens, or similar. The surface of a photosensitive body is subjected to optical recording by this optical system, whereupon a latent image formed by the optical recording is developed by toner and transferred onto a sheet of paper to form an image. The formed image is fixed by a fixing portion, and then discharged to the paper post-processing apparatus FR side by a conveyance roller 135. In this embodiment, the feed portion 133 is provided on four tiers, and a vertical conveyance path 136 is provided in a paper extraction direction on the right side of the drawing. In this manner paper extracted from each feed tier is supplied to the image writing portion 132.

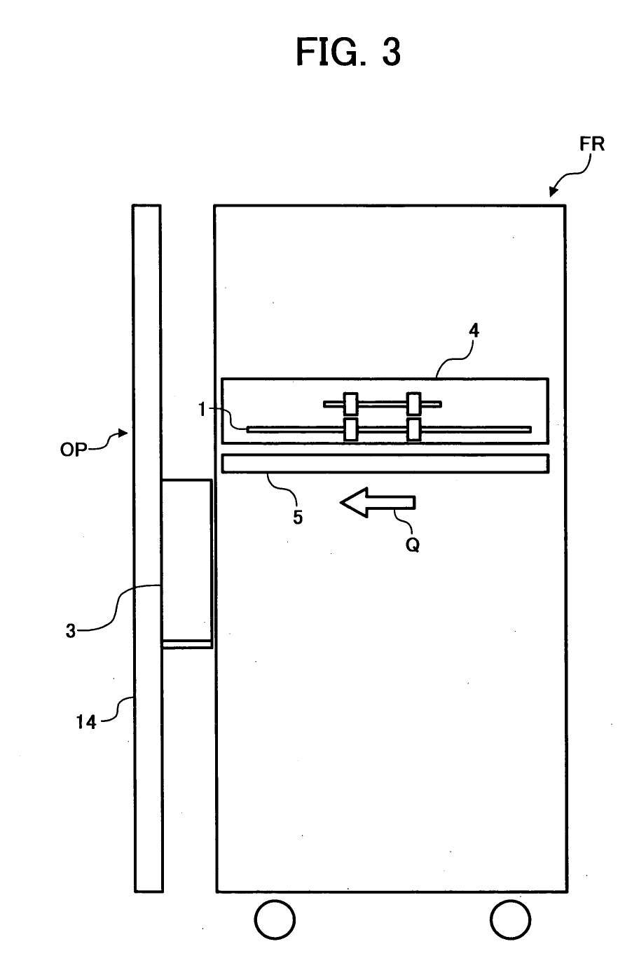

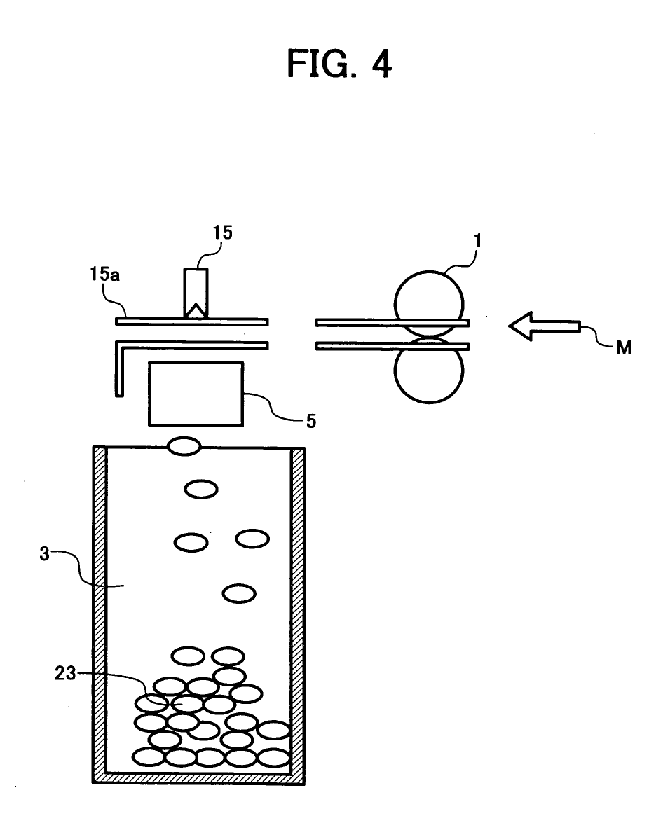

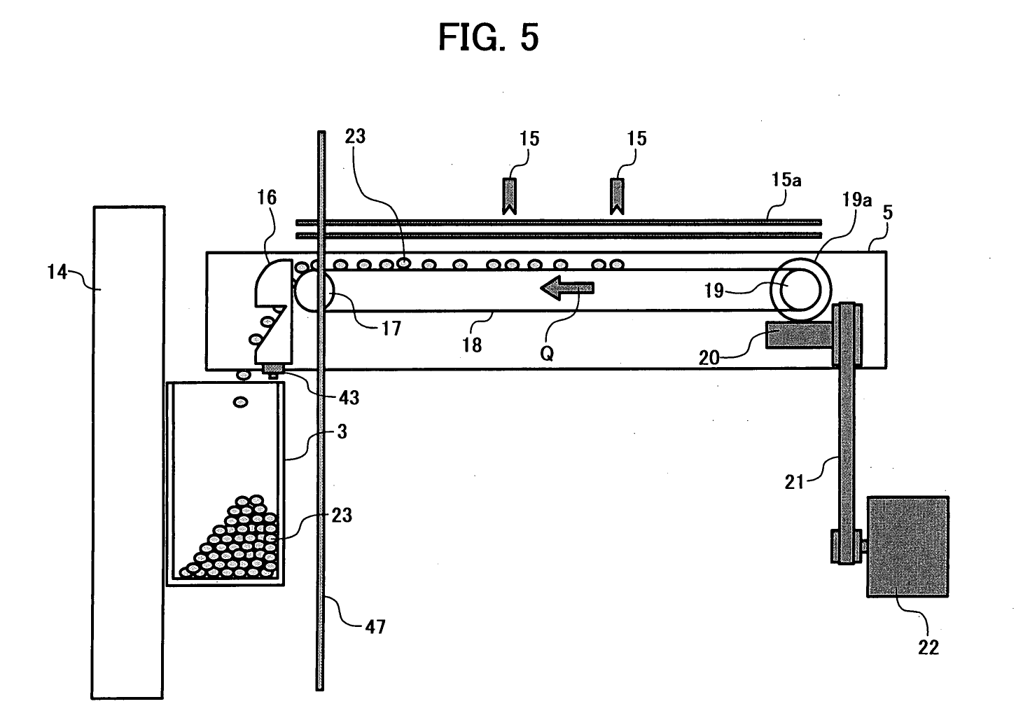

Paper formed with an image is fed into the paper post-processing apparatus FR from the image forming apparatus PR in the direction shown by an arrow M. The punching unit 4 for punching a hole in the paper conveyed from the image forming apparatus PR is provided in the paper post-processing apparatus FR on the downstream side of the inlet roller 1 and the upstream side of the conveyance roller 6 in the paper conveyance direction. The punch debris conveyance unit 5 for conveying the punch debris produced by punching is provided below the punching unit 4 in an orthogonal direction to the paper conveyance direction, as shown in FIG. 3. Punch debris 23 (see FIGS. 4, 5) is conveyed in a punch debris conveyance direction Q by the punch debris conveyance unit 5. The conveyance direction Q of the punch debris 23 leads to an operating side OP where a user performs operations, jam processing, and so on. The user stands on the operating side OP and inputs the desired processing into the paper post-processing apparatus FR or image forming apparatus PR through an operating portion 137, or performs toner replacement, paper jam processing, and so on. Toner replacement and paper jam processing are performed by opening a front cover 14 which is part of the casing on the operating side OP, and the punch debris storage hopper 3 is provided on the inside of the front cover 14. Hence punch debris is collected in the punch debris storage hopper 3 provided on the inside of the front cover 14. The punch debris conveyance unit 5 for conveying the punch debris 23 and the punch debris storage hopper 3 will be described in detail hereafter.

Paper P punched by the punching unit 4 is conveyed along various conveyance paths by bifurcation claws 27, 28 disposed downstream of the conveyance roller pair 6, sorted in the next post-process or subjected to a process such as stapling, and then stacked on a discharge tray 9. If the paper P is to be simply discharged, then the paper P travels along the upper conveyance path, and is discharged to and stacked on a proof tray 29.

If the paper P is to be sorted, the conveyance path on the conveyance roller pair 7 side is opened by the bifurcation claw 27 and the conveyance path on a conveyance roller pair 10 side is closed by the bifurcation claw 28 such that the paper P is discharged through a discharge roller pair 8 side to the side of the discharge tray 9 having a shift function. The shift function serves to sort the paper P into sets by moving the discharge tray 9 in an orthogonal direction to the paper conveyance direction for each set.

When the paper P is to be stapled, the conveyance path on the conveyance roller pair 7 side is opened by the bifurcation claw 27 and the conveyance path on the conveyance roller pair 10 side is opened by the bifurcation claw 28 such that the paper is discharged onto a stapling tray 12 through a stapling discharge roller 11. On the stapling tray 12, each sheet of paper is struck down to a rear end fence side by a striking roller, whereupon the end portions of the paper are aligned by a jogger fence in an orthogonal direction to the discharge direction. When one set of sheets has been collated, the paper end portions (the rear end here) are stapled by a stapler 13, whereupon the stapled set of paper is pushed upward to the discharge roller pair 8 side by an ejection belt and discharged to the shift tray 9.

By disposing the punching unit 4 and punch debris storage hopper 3 furthest upstream of the post-processes in this manner, holes can be punched in basically any type of paper, and the punched paper can then be discharged to the proof tray 29 as is, discharged to the shift tray 9 for sorting, or stapled and then discharged to the shift tray 9.

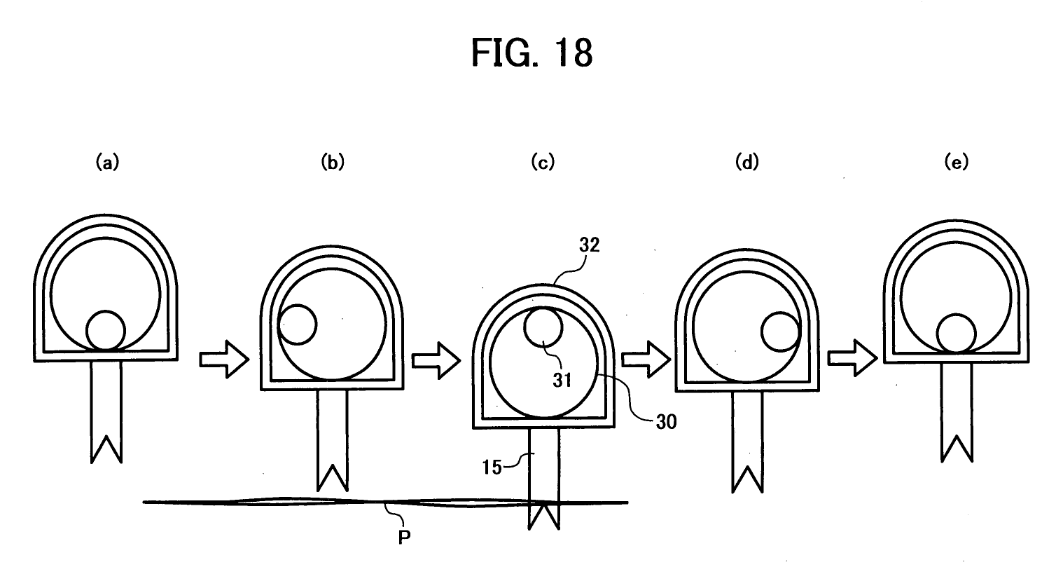

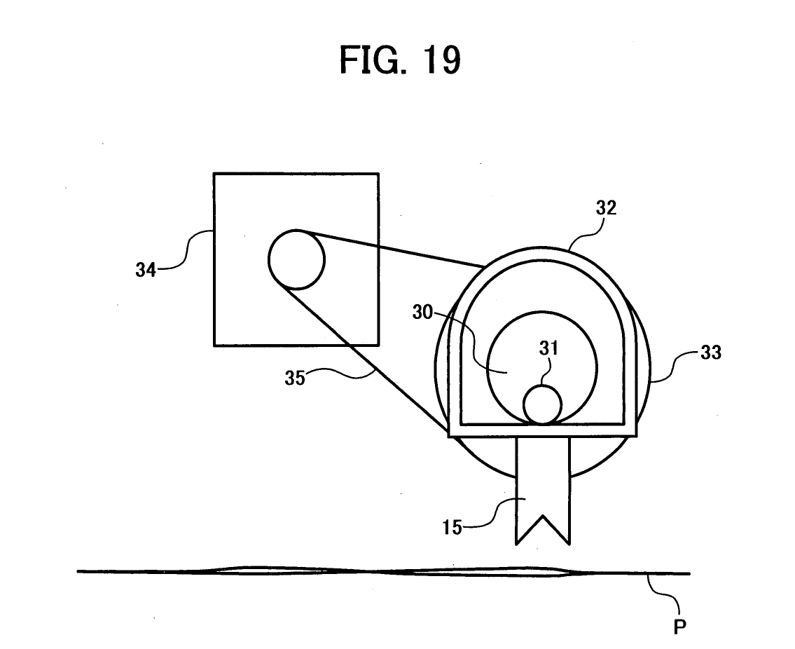

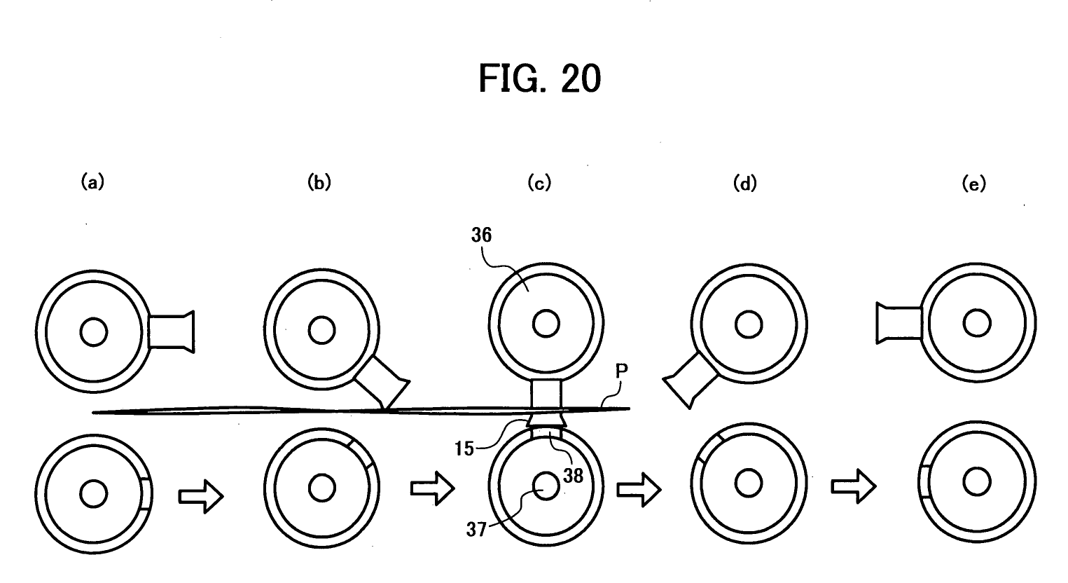

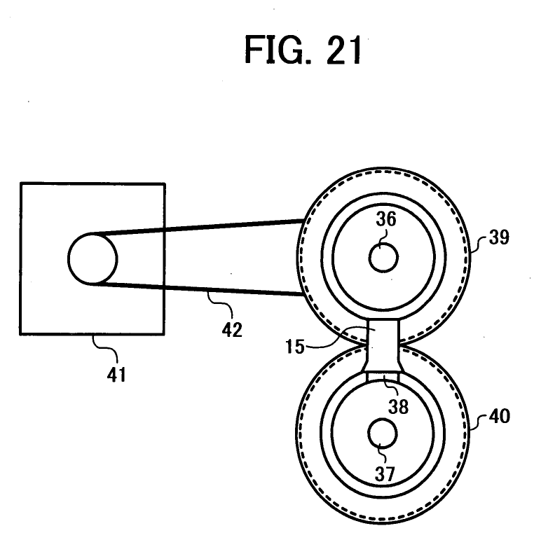

FIG. 4 is a view showing the punching unit 4 and punch debris storage hopper 3 in detail. The punching unit 4 punches a hole in the paper conveyed in the direction of the arrow M in FIG. 4 by an operation of a punching blade 15. The punching mechanism of the punching unit 4 may employ a press punching system (FIGS. 18, 19) which stops the paper in a predetermined position and then operates the punching blade 15 in a perpendicular direction to the paper conveyance direction (a vertical operation) to punch a hole in the paper, or a rotary punching system (FIGS. 20, 21) which punches a hole in the paper while the paper is conveyed by rotating the punching blade 15 in synchronization with the conveyance speed of the paper, or any other hole punching system. When the punching means are removed from the punched paper, the resulting punch debris 23 is dropped into the interior of the punch debris storage hopper 3 disposed on the front cover 14 side by the punch debris conveyance unit 5 provided below a paper guide 15a, and stored therein.

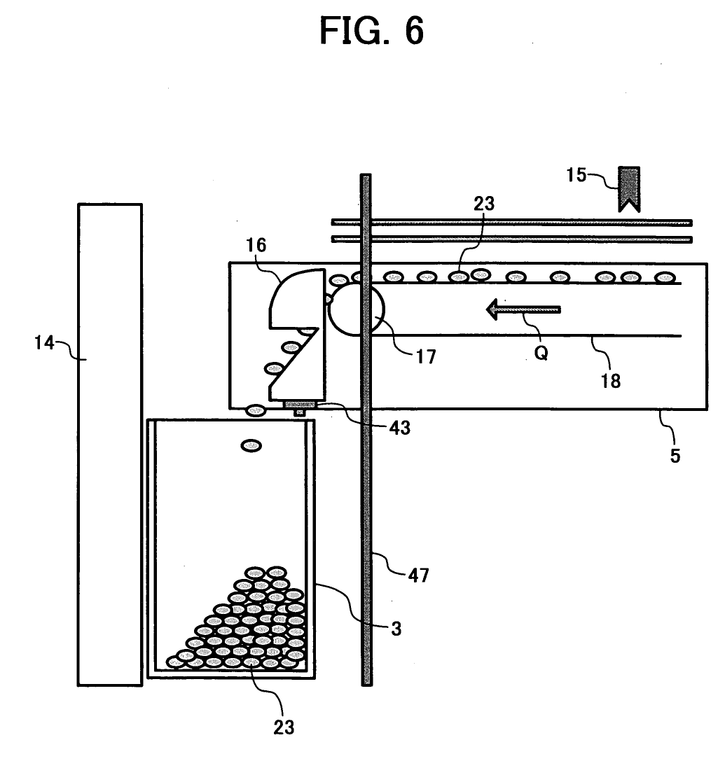

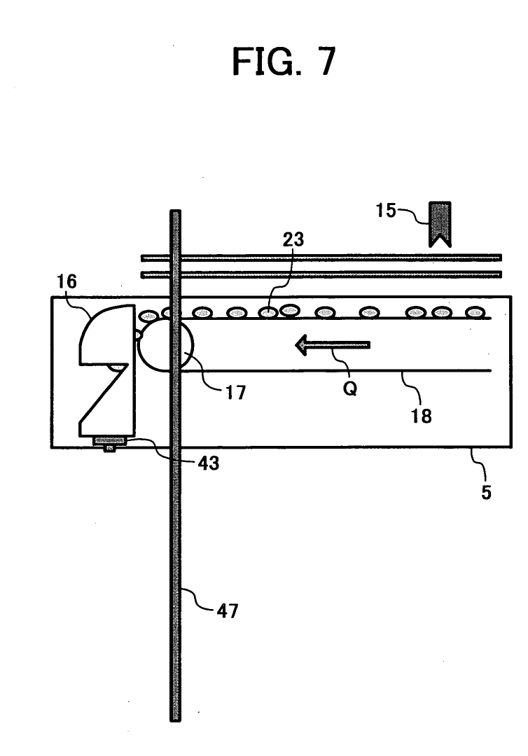

FIG. 5 shows the punch debris conveyance unit 5 in detail, and the positional relationship between the punch debris conveyance unit 5, the punching unit 4, and the punch debris storage hopper 3. FIG. 6 shows the positional relationship between the attachment and capacity sensor 43 mounted on a punch debris guide 16 and the punch debris storage hopper 3. FIG. 7 shows the attachment and capacity sensor 43 mounted on the punch debris guide 16.

In these drawings, the paper is guided to the position of the punching blade 15 by the paper guide 15a, stopped temporarily in the punching position, and punched by lowering the punching blade 15 to the paper side. The punch debris 23 produced by the punching operation of the punching blade 15 falls onto a punch debris conveyor belt 18 of the punch debris conveyance unit 5 provided below the paper guide 15a. The punch debris conveyor belt 18 is wrapped around a driven side timing pulley 17 and a drive side timing pulley 19 at a predetermined tension, and the side of the punch debris conveyor belt 18 onto which the punch debris 23 falls moves in the direction of an arrow Q in FIG. 5 (a punch debris conveyance direction). Accordingly, the punch debris 23 is conveyed to the operating (front cover 14) side OP. A worm wheel 19a joined integrally to the drive side timing pulley 19 meshes with a worm 20, and the punch debris conveyor belt 18 is rotated in the counter clockwise direction of the drawing by the rotation of the worm 20. Thus the punch debris 23 can be conveyed in the direction Q. The worm 20 is driven to rotate by a stepping motor 22 via a timing belt 21. Having been conveyed to the operating side OP by the punch debris conveyor belt 18, the punch debris 23 passes through the punch debris guide 16 and falls into the interior of the punch debris storage hopper 3, where it is stored. The punch debris storage hopper 3 is mounted detachably on the inside (the paper post-processing apparatus interior side) of the openable front cover 14, as will be described hereafter. The attachment and capacity sensor 43 for detecting the accumulated amount of punch debris 23 and the attachment state of the punch debris storage hopper 3, as will be described hereafter, is mounted on the lower portion of the punch debris guide 16. The front cover 14 is opened and closed during jam processing or toner replacement, and at this time, the punch debris storage hopper 3 oscillates such that the mountain of accumulated punch debris 23 collapses and becomes flat. As a result, the capacity storage amount increases. Note that the reference numeral 47 denotes a front side plate.

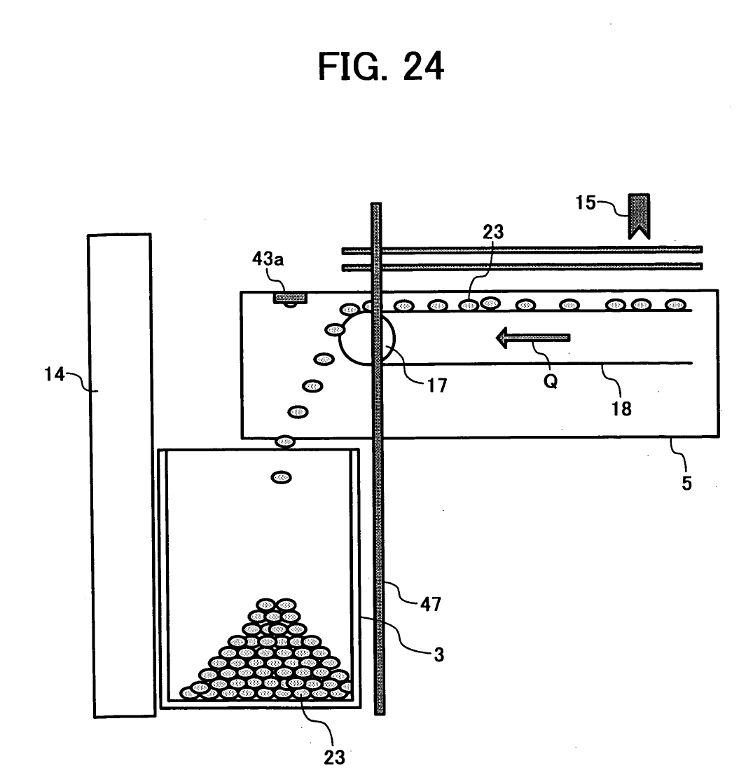

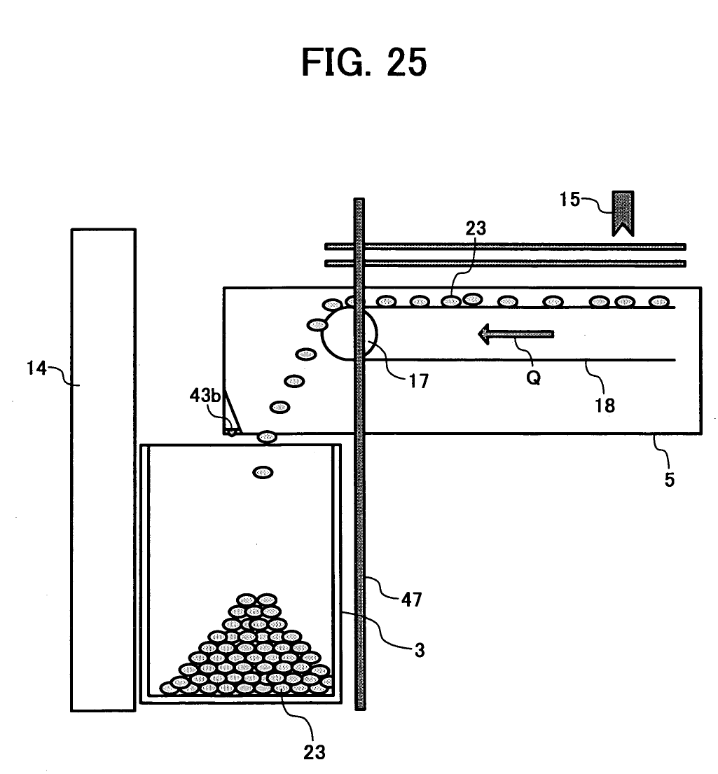

The punch debris guide 16 functions to guide the direction in which the punch debris falls, but if the opening area of the punch debris storage hopper 3 is large, for example, so that the punch debris can be stored within the punch debris storage hopper 3 reliably, the punch debris guide 16 need not be provided. In such a case, as shown in FIGS. 24 and 25, for example, the attachment and capacity sensor 43 may be provided on an inner surface of the punch debris conveyance unit 5 facing the bottom surface of the punch debris storage hopper 3 (FIG. 24), or attachment and capacity sensors 43a, 43b may be provided in an opening portion of the punch debris storage hopper 3 (FIG. 25). In either case, the sensor should be positioned to be able to detect the highest part of the punch debris 23.

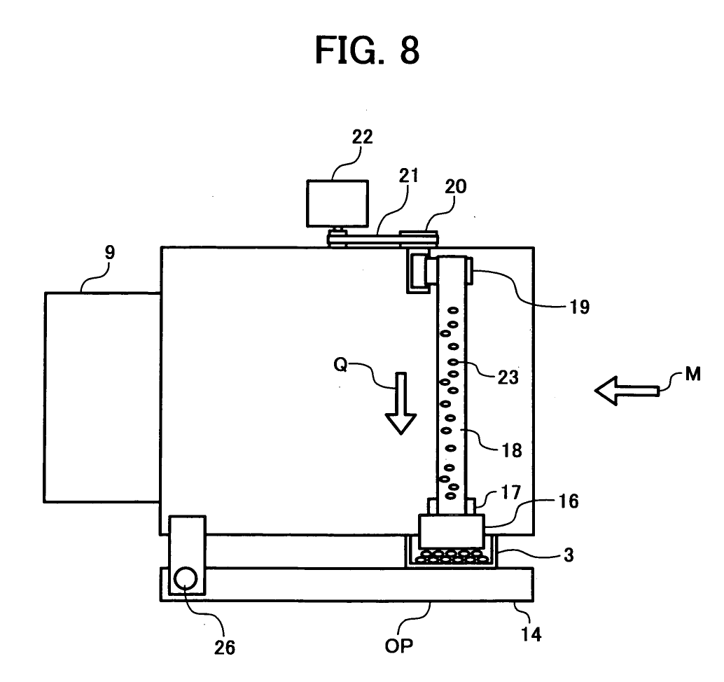

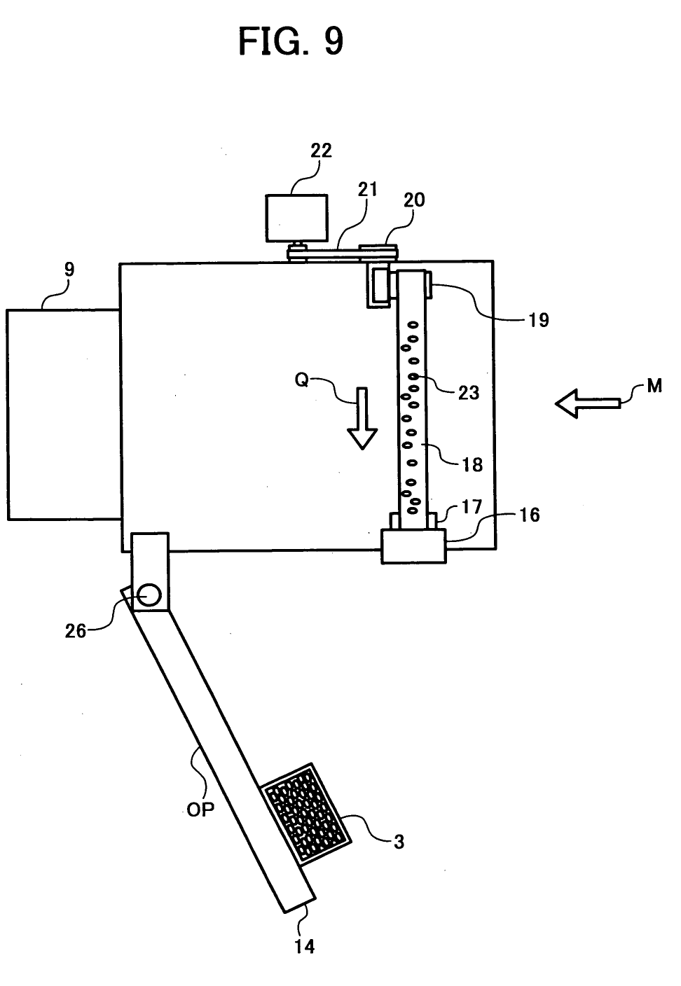

FIGS. 8 and 9 show the punch debris conveyance mechanism of the paper post-processing apparatus FR. FIG. 8 shows a normal usage condition in which the front cover 14 is closed, and FIG. 9 shows a state in which the front cover 14 is open. As can be seen from FIG. 9, the front cover 14 is provided rotatably about a spindle 26 provided on the left side of the paper post-processing apparatus FR main body when seen from the operating side OP. When the front cover 14 is opened, the punch debris storage hopper 3 opens integrally therewith, and when the front cover 14 is closed, the punch debris storage hopper 3 closes integrally therewith.

As shown in FIG. 8, when the front cover 14 is closed, the punch debris storage hopper 3 blocks the conveyance path when seen from the operating side OP such that if an attempt is made to open or close a conveyance guide plate to perform jam processing or the like, the punch debris storage hopper 3 is fixed in the position shown in FIG. 2 and must be removed to permit the jam processing or the like. Hence, when the front cover 14 is opened to perform jam processing or the like, the punch debris storage hopper 3 must be moved integrally with the front cover 14. In other words, if the punch debris storage hopper 3 moves together with the front cover 14 when the front cover 14 is opened so as not to obstruct jam processing or the like, the punch debris storage hopper 3 can be enlarged, and hence the punch debris storage capacity can be increased.

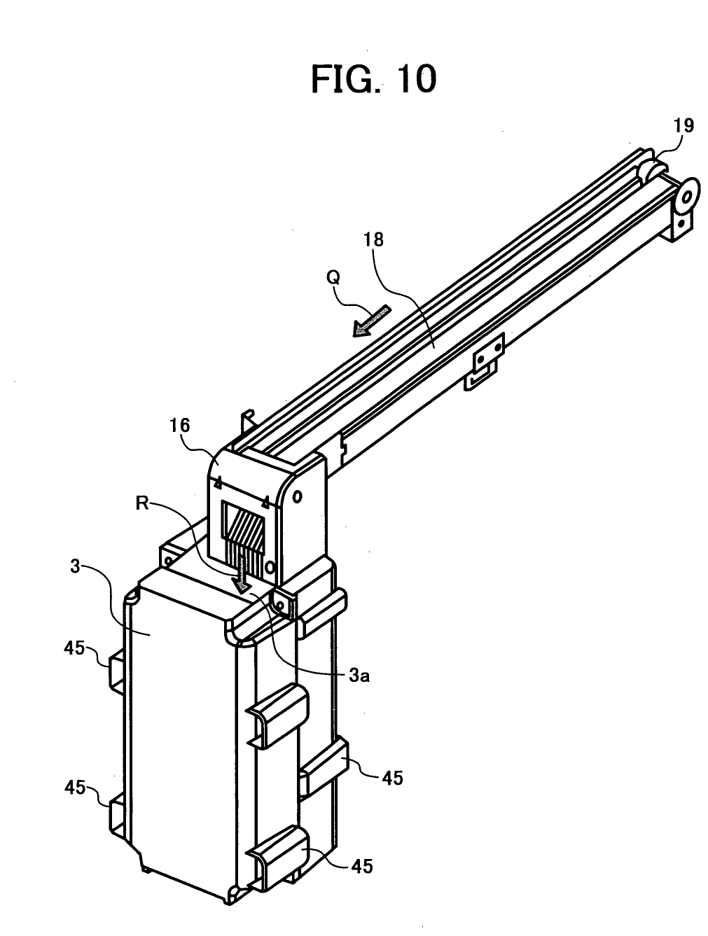

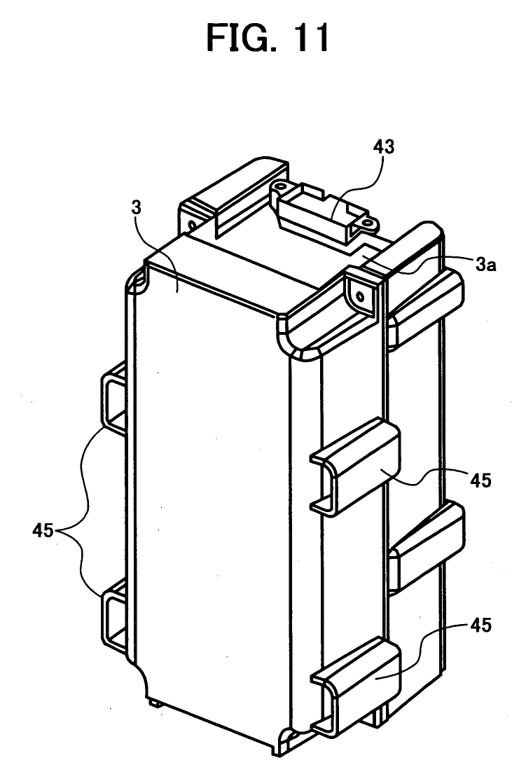

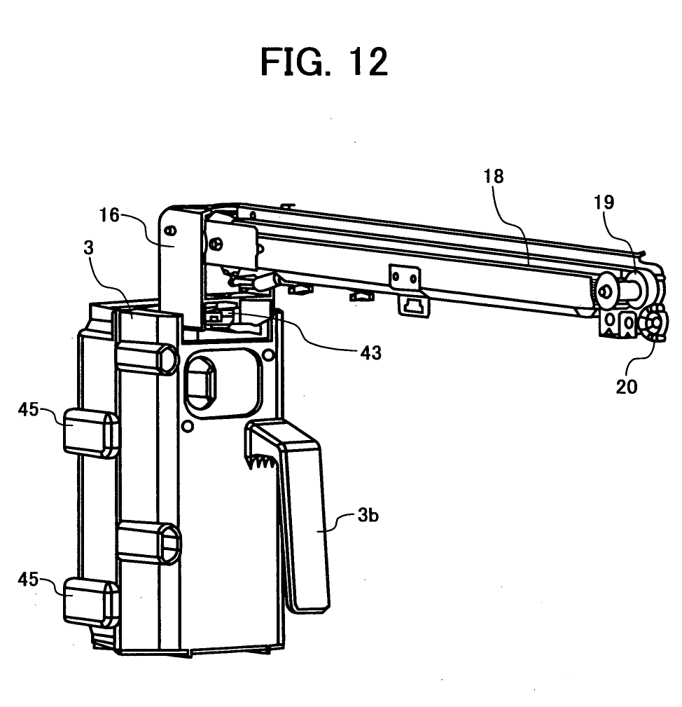

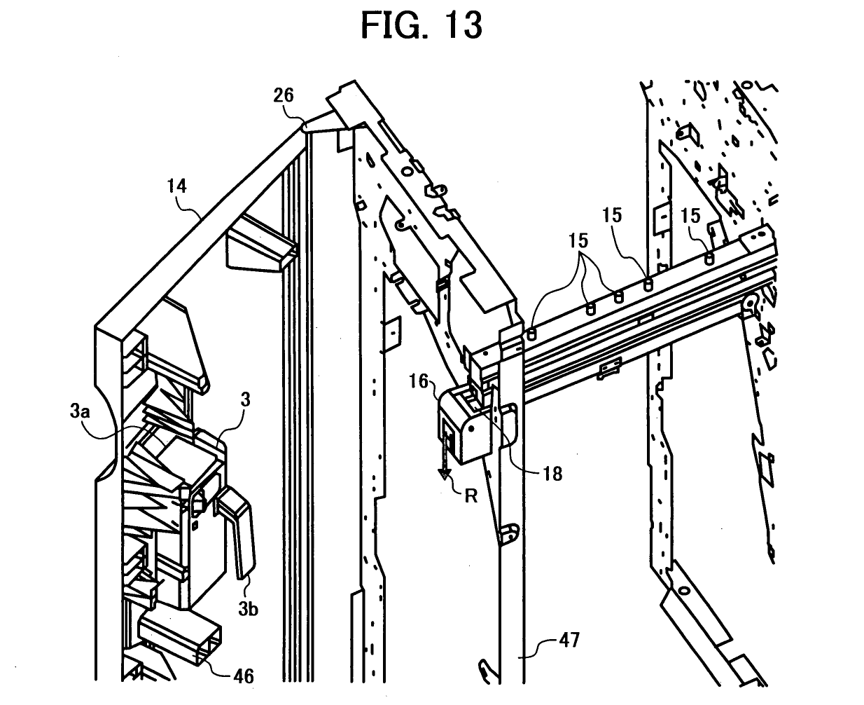

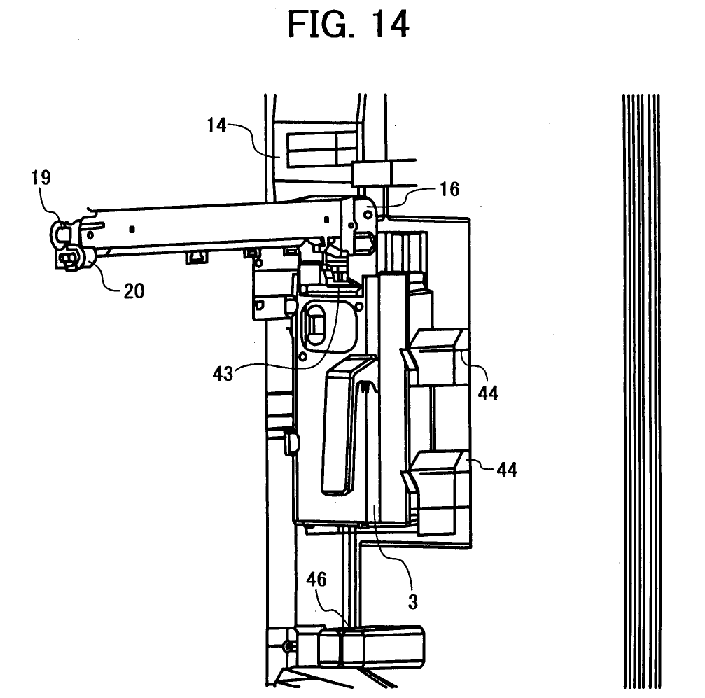

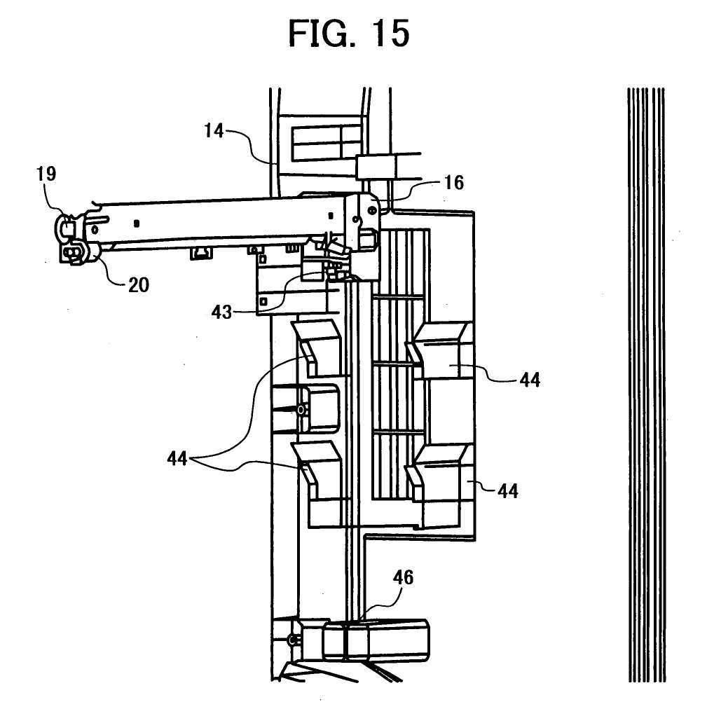

FIGS. 10 through 15 show the punch debris storage hopper 3, punch debris conveyance unit 5, front cover 14, attachment and capacity sensor 43, and so on in further detail. FIG. 10 shows the punch debris conveyance unit 5 and punch debris storage hopper 3, FIG. 11 shows the positional relationship by which the attachment and capacity sensor 43 is mounted on the punch debris storage hopper 3, FIG. 12 shows the punch debris conveyance unit 5 and punch debris storage hopper 3 from the drive side of the punch debris conveyor belt 18, FIG. 13 shows the positional relationship between the punch debris conveyance unit 5 and punch debris storage hopper 3 when the front cover 14 is open, FIG. 14 shows the positional relationship between the punch debris conveyance unit 5 and the punch debris storage hopper 3 when the front cover 14 is closed, and FIG. 15 shows a state in which the punch debris storage hopper 3 is detached from the front cover 14 when the front cover 14 is closed.

As shown in FIG. 10, the punch debris 23, having been conveyed in the direction of the arrow Q by the punch debris conveyor belt 18 of the punch debris conveyance unit 5, passes through the punch debris guide 16 and falls onto an upper surface opening portion 3a of the punch debris storage hopper 3 in the direction of an arrow R, and is thus stored in the interior of the punch debris storage hopper 3. As shown in FIG. 11, the attachment and capacity sensor 43 is mounted on the punch debris guide 16 so as to peek through the upper surface opening portion 3a of the punch debris storage hopper 3 as shown in FIGS. 11 and 12. As shown in FIGS. 10 to 14, two protruding ear portions 45 are provided on each side face of the punch debris storage hopper 3, or in other words on the front cover, with a gap therebetween in the vertical direction.

As shown in FIGS. 14 and 15, four holders 44 are provided on the inside of the openable front cover 14 (the interior side of the paper post-processing apparatus FR) so as to sandwich the punch debris storage hopper 3 and support the four ear portions 45. As shown in FIG. 14, a shielding protrusion 46 is also formed on the inside of the front cover 14 so as to be positioned at a remove from the bottom portion of the punch debris storage hopper 3 when the punch debris storage hopper 3 is attached. The shielding protrusion 46 erves to reflect light emitted from the attachment and capacity sensor 43 when the punch debris storage hopper 3 is detached from the holders 44, and return this light to the attachment and capacity sensor 43.

The attachment and capacity sensor 43 is constituted by a well-known, downward-looking sensor also referred to as a range sensor, which measures distance by receiving light that is emitted from the attachment and capacity sensor 43 constantly and reflected by an object, and reading the voltage fluctuation produced by the intensity of the reflection light. In other words, various information can be read from the voltage fluctuation value of the attachment and capacity sensor 43 using the detected distance as a threshold. Accordingly, a difference emerges between a voltage value corresponding to light from the attachment and capacity sensor 43 which impinges on and is reflected by the bottom portion of the punch debris storage hopper 3 or the upper surface of the accumulated punch debris 23 when the punch debris storage hopper 3 is mounted on the front cover 14 as shown in FIG. 14, and a voltage value corresponding to light from the attachment and capacity sensor 43 which impinges on and is reflected by the shielding protrusion 46 when the punch debris storage hopper 3 is not mounted on the front cover 14 as shown in FIG. 15. Hence, this voltage differential can be used to determine whether or not the punch debris storage hopper 3 is attached. The voltage value corresponding to the reflected light also differs according to the amount of punch debris 23 stored in the punch debris storage hopper 3, and hence this can be used to determine whether the punch debris storage hopper 3 is filled to capacity or near capacity, the latter indicating that the punch debris storage hopper 3 is almost full.

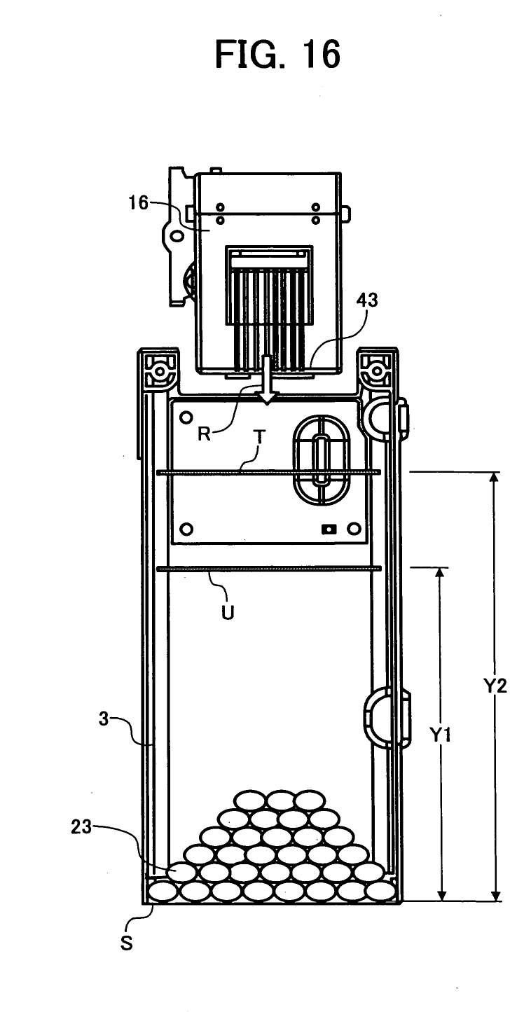

FIG. 16 shows the capacity and near capacity positions of the punch debris storage hopper 3. Assuming that a state in which no punch debris 23 is stored in the punch debris storage hopper 3 corresponds to an attachment position S, a state in which the punch debris 23 is stored to a height Y1 corresponds to a near capacity position U, and a state in which the punch debris 23 is stored to a height Y2 corresponds to a capacity position T, as shown in FIG. 16, all of these states can be confirmed by measuring the distance from the attachment and capacity sensor 43 to the respective positions. This information may then be transmitted from the paper post-processing apparatus FR to the image forming apparatus PR as a signal, and notified to the operator.

As a default, the capacity position T at the height Y2 in FIG. 16 is set a certain distance (approximately 50 mm) from the opening portion of the punch debris storage hopper 3. This is a safety measure taken to prevent the punch debris 23 from overflowing through the opening portion 3a when the punch debris storage hopper 3 oscillates as a result of the front cover 14 being closed forcefully. Note, however, that the maximum capacity position may be modified by adjusting an SP mode or the like on the operating portion 137 of the image forming apparatus PR. In so doing, the capacity position can be raised in cases where the user does not intend to close the front cover 14 forcefully and wishes to store more punch debris 23. In other words, the capacity position may be set in accordance with the usage manner of each user.

(Electric Constitution)

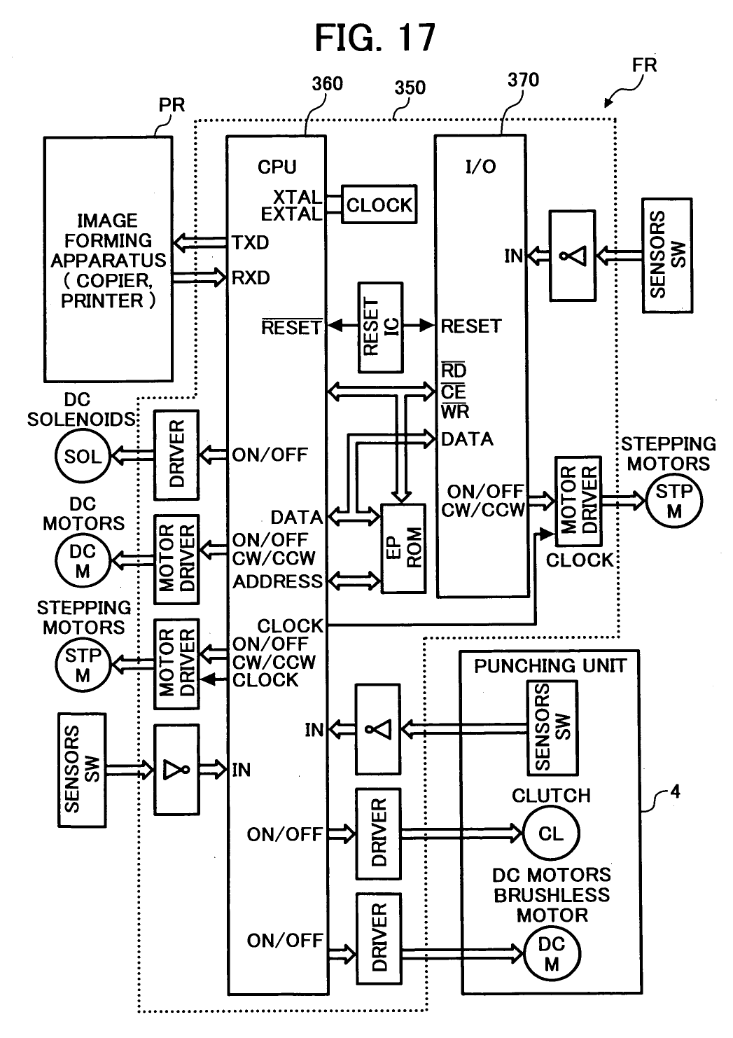

As shown in FIG. 17, the control apparatus 350 is constituted by a microcomputer comprising the CPU 360, an I/O interface 370, and so on. Signals from various switches and the like on the operating portion 137 of the image forming apparatus PR main body, an inlet sensor 2, the attachment and capacity sensor 43, a paper discharge sensor for detecting paper discharge onto the discharge tray 9, a sensor for detecting the height of the paper surface on the discharge tray 9, and so on are input into the CPU 360 through the I/O interface 370.

On the basis of these input signals, the CPU 360 controls the vertical operation of the punching blade 15 on the punching unit 4, the conveyance operation of the punch debris conveyance unit 5, the alignment operation (jogging operation) on the stapling tray 12 in an orthogonal direction to the paper conveyance direction, the stapling operation of the stapling unit 13, the operation to discharge the stapled set of paper, the raising and lowering operations of the discharge tray 9, the operation of the striking roller to strike the paper down to the rear end fence side in order to align the paper in a parallel direction to the paper conveyance direction, and so on. The CPU 360 also calculates in advance and stores voltage values which differ according to the attachment state of the punch debris storage hopper 3 and the capacity or near-capacity positions of the punch debris, detected by the attachment and capacity sensor 43. A pulse signal from a stapling conveyance motor, not shown in the drawings, which drives the stapling discharge roller 11 is input into the CPU 360 and counted, and the striking roller and jogging operation are controlled in accordance with the counted value.

Note that control of the paper post-processing apparatus FR is performed by having the CPU 360 execute a program written in a ROM, not shown, while using a RAM, not shown, as a work area. Further, the program data may be downloaded from a server via a network, or from a recording medium via a recording medium driving apparatus, and upgraded.

(Press Punching System)

FIG. 18 is a view illustrating a hole punching operation when a press punching system is employed in the punching unit 4, and FIG. 19 shows the schematic constitution of a drive system for a press mechanism used to perform a pressing operation for hole punching. In FIG. 18, A shows an initial state, B shows a state in which punching has begun, C shows a state during punching, D shows a state immediately after punching, and E shows a return to the initial state.

As shown in FIG. 19, the punching blade 15 operates perpendicular to the conveyed paper P by means of a cam 30 which rotates about a shaft 31. A hole is punched in the paper P in the state shown in FIG. 18C. The hole is punched into the paper P after the elapse of a fixed time period following the passage of the rear end of the paper P through the inlet sensor 2 of FIG. 2, or when the paper P is stopped after a fixed pulse. At this time, the cam 30, which is attached rotatably to the shaft 31 in order to rotate integrally with the shaft 31, rotates about the shaft 31 such that an inner wall of a holder 32 which contacts the outer peripheral surface of the cam 30 is pushed downward to the paper P side. The downwardly-pushed holder 32 pushes the punching blade 15, which is engaged with the holder 32, down to the paper P side, and thus a hole is punched in the paper P.

A pulley 33 is mounted on the shaft 31, and the pulley 33 is driven to rotate by a stepping motor 34 via a timing belt 35. The pulley 33 may be rotated constantly by the stepping motor 34 via the timing belt 35, whereby the drive force generated by the stepping motor 34 is transmitted from the pulley 33 to the shaft 31 as required using a single revolution clutch, or this drive force may be transmitted to the shaft 31 by stopping and driving the stepping motor 34 repeatedly.

(Rotary Punching System)

FIG. 20 is a view illustrating a hole punching operation when a rotary punching system is employed in the punching unit 4, and FIG. 21 shows the schematic constitution of a drive system for a rotary mechanism. In FIG. 20, A shows an initial state, B shows a state in which punching has begun, C shows a state during punching, D shows a state immediately after punching, and E shows a 90 degree rotation from the state during punching.

As shown in FIG. 21, the punching blade 15 rotates about a shaft 36. Meanwhile, a die 38 positioned so as to form a pair with the punching blade 15 rotates about a shaft 37. The punching blade 15 and die 38 begin to rotate in alignment with the conveyance operation of the paper P following the elapse of a preset number of pulses after the rear end of the conveyed paper P has passed through the inlet sensor 2 of FIG. 2, and a hole is punched in the paper P in the state shown in FIG. 20C. More specifically, the punching blade 15 and die 38 are mounted respectively on a pair of rotary bodies which sandwich the paper P, and these rotary bodies rotate about the shaft 36 and shaft 37 respectively. Gears 39 and 40 are mounted on the shafts 36, 37 of the punching blade 15 and die 38 respectively, and the rotation of the rotary bodies is transmitted through the meshing of the two gears. The driving force from the stepping motor 41 is transmitted to the gear 39 on the punching blade 15 side via a timing belt 42.

When the punching unit 4 employs this rotary punching system, the punching operation can be performed without stopping the paper. Hence the image forming speed of the image forming apparatus need not be taken into account, and since the paper P does not have to be stopped, control is facilitated.

(Control Procedure)

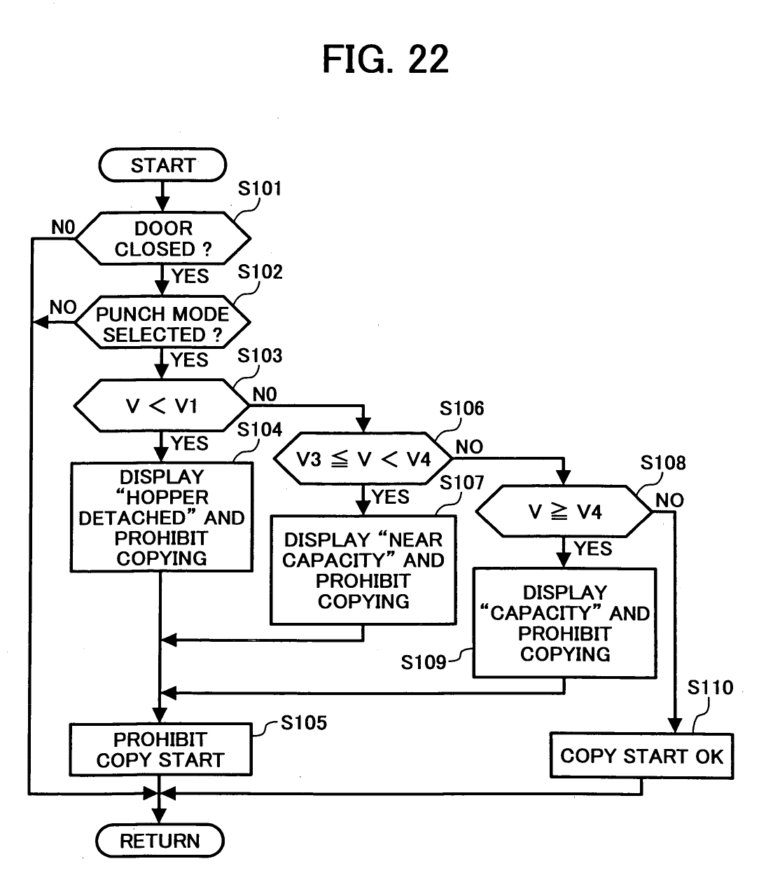

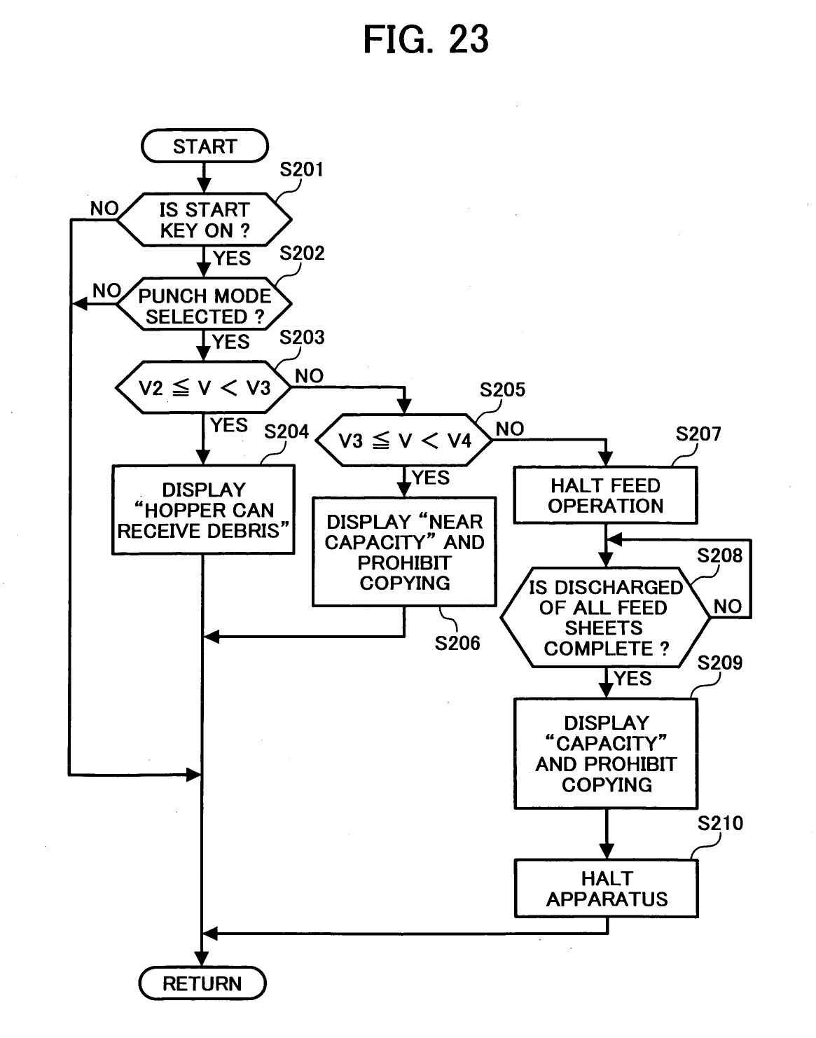

FIGS. 22 and 23 are flowcharts showing control procedures for detecting the attachment state of the punch debris storage hopper 3 and the accumulation state of the punch debris 23.

When detecting the attachment state of the punch debris storage hopper 3 or the storage state of the punch debris 23, a voltage valve v1 produced when light emitted from the attachment and capacity sensor 43 is reflected by the shielding protrusion 46 and received in the attachment and capacity sensor 43, a voltage value v2 produced when the light emitted from the attachment and capacity sensor 43 is reflected by the bottom portion of the punch debris storage hopper 3 and received in the attachment and capacity sensor 43, a voltage value v3 produced when the punch debris 23 is stored up to the height Y1 corresponding to the near capacity position U such that the light emitted from the attachment and capacity sensor 43 is reflected by this punch debris and received in the attachment and capacity sensor 43, and a voltage valve v4 produced when the punch debris 23 is stored up to the height Y2 corresponding to the capacity position T such that the light emitted from the attachment and capacity sensor 43 is reflected by this punch debris and received in the attachment and capacity sensor 43, are measured in advance, and the resulting numerical values are stored in the ROM or the like of the control apparatus 350. Note that the voltage values v3 and v4 corresponding to the near capacity position U and capacity position T respectively vary slightly according to the material, paper quality, and accumulation state of the punch debris 23, and should therefore be set in a certain range.

This control is performed during a copying operation or during standby, for example when the power switch of the image forming apparatus PR is switched ON or OFF, or when the various setting buttons are operated. FIG. 22 shows the control procedure performed during standby. In this processing, first checks are made to determine whether or not the front cover 14 (door) is closed (step S101) and whether or not a punch mode has been selected (step S102). If the front cover is closed and punch mode has been selected, a determination is made as to whether or not a voltage value v obtained upon light reception in the attachment and capacity sensor 43 is smaller than the voltage value v1 (v<v1) (step S103). If the voltage value v is smaller than the voltage value v1, then the punch debris hopper 3 is not attached, and hence a message indicating this is displayed on a display panel (not shown) of the operating portion 137, and copying is prohibited (step S104). If the voltage value v is equal to or greater than the voltage value v1, a determination is made as to whether or not the voltage value v is equal to or greater than the voltage value v3 and less than the voltage value v4 (v3≦v<V4) (step S106). If the determination result is positive, then the punch debris storage hopper 3 is near capacity, and hence a message indicating this is displayed and copying is prohibited (step S107). If the voltage value v is equal to or greater than the voltage value v4 (step S108), the punch debris storage hopper 3 is at capacity, and hence a message indicating this is displayed and copying is prohibited (step S109). If the voltage value v satisfies v1≦v<v3, then the punch debris hopper is attached and the accumulated amount of the punch debris 23 is less than near capacity, and hence “copy start OK” is set (step S110) and the control routine advances to “return”. When copying is prohibited in the steps S104, S107, and S109, copying cannot be started on the image forming apparatus PR, and therefore wasteful operations are not performed.

Since copying is prohibited if the punch debris storage hopper 3 is determined to be unattached in the flowchart in FIG. 22, during a copying operation the punch debris storage hopper 3 is always attached, and the voltage value v satisfies the condition v≧v2. In this state, as shown in FIG. 23, if a start key is ON (step S201) and the punch mode has been selected (step S202), a determination is made as to whether or not the voltage value v satisfies v2≦v<v3 (step S203), and if so, a message indicating that the punch debris storage hopper 3 is able to receive punch debris is displayed on the display panel (not shown) of the operating portion 137 (step S204). If the voltage value v is outside the range of v2≦v<v3 in the step S203, a further determination is made as to whether or not the voltage value v satisfies v3≦v<v4 (step S205). If so, the punch debris storage hopper 3 is near capacity, and hence a message indicating this is displayed. If the voltage value v does not satisfy v3≦v<v4, or in other words if the voltage value v satisfies v≧v4, all paper feed operations are halted (step S207), all discharged sheets are discharged, and when discharge is complete (step S208), a message indicating that the punch debris storage hopper 3 is at capacity is displayed and copying is prohibited (step S209). The apparatus itself is also stopped (step S210).

Thus the operator can be informed by the attachment and capacity sensor 43 of the attachment state of the punch debris storage hopper 3 and the storage state of the punch debris 23, and copying can be prohibited as required.

According to this embodiment, the following features are obtained.

(1) The distance to the punch debris accumulation surface is detected directly, and hence the accumulation state of the punch debris can be grasped accurately.

(2) A difference in distance can be recognized when the punch debris storage means are attached and detached, and it is therefore possible to determine whether or not the punch debris storage means are attached.

(3) The distance to the punch debris accumulation surface can be detected, and hence according to this distance, a capacity state, a near capacity state, and the gradual accumulation state of the punch debris can be grasped and output as signals.

(4) By detecting the distance to the punch debris accumulation surface and outputting a punch debris capacity detection signal according to the distance detection information, the setting for the detected distance at which the capacity signal is output can be modified, and hence a user or service person can alter the setting of the capacity position. Thus the punch debris storage amount can be increased or decreased relatively freely, and hence a specification suited to each individual user can be provided.

According to the present invention, the distance to the punch debris accumulation surface is detected directly, and hence the accumulation state of the punch debris can be grasped accurately.

Various modifications will become possible for those skilled in the art after receiving the teachings of the present disclosure without departing from the scope thereof.

1. A paper processing apparatus comprising:
paper conveyance means for conveying paper discharged from an image forming apparatus;
punching means for punching a hole in the paper conveyed by the paper conveyance means;
punch debris storage means for storing punch debris which falls from the punching means; and
detection means constituted by a range sensor for detecting an accumulation height of the punch debris stored in the punch debris storage means.

2. The paper processing apparatus as claimed in claim 1, wherein the detection means are provided in a position opposite an inner bottom surface of the punch debris storage means.

3. A paper processing apparatus comprising:
paper conveyance means for conveying paper discharged from an image forming apparatus;
punching means for punching a hole in the paper conveyed by the paper conveyance means;
punch debris conveyance means for conveying punch debris punched out of the paper by the punching means;
punch debris storage means for storing the punch debris that falls from the punch debris conveyance means; and
detection means constituted by a range sensor for detecting an accumulation height of the punch debris stored in the punch debris storage means.

4. The paper processing apparatus as claimed in claim 3, further comprising punch debris guiding means for guiding the punch debris conveyed by the punch debris conveyance means to the punch debris storage means.

5. The paper processing apparatus as claimed in claim 4, wherein the detection means are mounted on a lower surface of the punch debris guiding member.

6. The paper processing apparatus as claimed in claim 3, wherein the detection means are provided in a position opposite an inner bottom surface of the punch debris storage means.

7. A paper processing apparatus comprising:
paper conveyance means for conveying paper discharged from an image forming apparatus;
punching means for punching a hole in the paper conveyed by the paper conveyance means;
punch debris conveyance means for conveying punch debris punched out of the paper by the punching means;
punch debris guiding means for conveying the punch debris that falls from the punching means to punch debris storage means for storing the punch debris; and
detection means for detecting an accumulation surface of the punch debris from an accumulation direction of the punch debris which accumulates in the punch debris storage means from the punch debris guiding means.

8. The paper processing apparatus as claimed in claim 7, further comprising control means for detecting the height of the accumulation surface of the punch debris using a detection element that is emitted from the detection means and reflected on the accumulation surface of the punch debris.

9. The paper processing apparatus as claimed in claim 8, wherein, when the punch debris storage means are detached, the control means detect the absence of the punch debris storage means according to the detection element which is reflected by a member positioned below the punch debris storage means.

10. The paper processing apparatus as claimed in claim 8, wherein the control means emit a signal indicating that the punch debris storage means are full when the detection element is reflected from a position of the accumulation surface of the punch debris indicating that the punch debris storage means are filled to capacity with the punch debris.

11. The paper processing apparatus as claimed in claim 8, wherein the control means emit a near-capacity signal indicating that the punch debris storage means are almost full when the detection element is reflected from a position of the accumulation surface of the punch debris indicating that the punch debris storage means are almost filled to capacity with the punch debris.

12. The paper processing apparatus as claimed in claim 7, wherein the detection means are provided in a position opposite an inner bottom surface of the punch debris storage means.

13. The paper processing apparatus as claimed in claim 7, wherein the detection means are mounted on a lower surface of the punch debris guiding member.

14. An image forming system in which a paper processing apparatus and an image forming apparatus for forming a visible image on a recording medium are provided integrally or separately, wherein the paper processing apparatus comprises:
paper conveyance means for conveying paper discharged from an image forming apparatus;
punching means for punching a hole in the paper conveyed by the paper conveyance means;
punch debris storage means for storing punch debris which falls from the punching means; and
detection means constituted by a range sensor for detecting an accumulation height of the punch debris stored in the punch debris storage means.

15. An image forming system in which a paper processing apparatus and an image forming apparatus for forming a visible image on a recording medium are provided integrally or separately, wherein the paper processing apparatus comprises:
paper conveyance means for conveying paper discharged from an image forming apparatus;
punching means for punching a hole in the paper conveyed by the paper conveyance means;
punch debris conveyance means for conveying punch debris punched out of the paper by the punching means;
punch debris storage means for storing the punch debris that falls from the punch debris conveyance means; and
detection means constituted by a range sensor for detecting an accumulation height of the punch debris stored in the punch debris storage means.

16. An image forming system in which a paper processing apparatus and an image forming apparatus for forming a visible image on a recording medium are provided integrally or separately, wherein the paper processing apparatus comprises:
paper conveyance means for conveying paper discharged from an image forming apparatus;
punching means for punching a hole in the paper conveyed by the paper conveyance means;
punch debris conveyance means for conveying punch debris punched out of the paper by the punching means;
punch debris guiding means for conveying the punch debris that falls from the punching means to punch debris storage means for storing the punch debris; and
detection means for detecting an accumulation surface of the punch debris from an accumulation direction of the punch debris which accumulates in the punch debris storage means from the punch debris guiding means.
